(19) United States
(12) Patent Application Publication
(10) Pub. No.: US 2022/0397338 A1
(43) Pub. Date: Dec. 15, 2022

(54) INVENTORY MANAGEMENT SYSTEM IN A REFRIGERATOR APPLIANCE

(71) Applicant: Haier US Appliance Solutions, Inc., Wilmington, DE (US)

(72) Inventors: Choon Jae Ryu, Prospect, KY (US); Stephanos Kyriacou, Louisville, KY (US)

(21) Appl. No.: 17/346,337

(22) Filed: Jun. 14, 2021

(51) Int. Cl. F25D 29/00

(52) U.S. Cl. CPC F25D 29/005; F25D 2500/06; F25D 2700/06

(57) ABSTRACT

A refrigerator appliance is provided including a cabinet defining a chilled chamber, a door rotatably hinged to the cabinet to provide selective access to the chilled chamber, and an inventory management system mounted within the chilled chamber for monitoring objects positioned within the chilled chamber. The inventory management system may include a noncontact scanning device, such as a three-dimensional light detection and ranging (LiDAR) sensor, a camera assembly, and/or one or more weight sensors that work together to detect, identify, and locate objects positioned within the chilled chamber.

### FIELD OF THE INVENTION

The present subject matter relates generally to refrigerator appliances, and more particularly to methods of operating an inventory management system in a refrigerator appliance.

### BACKGROUND OF THE INVENTION

Refrigerator appliances generally include a cabinet that defines a chilled chamber for receipt of food articles for storage. In addition, refrigerator appliances include one or more doors rotatably hinged to the cabinet to permit selective access to food items stored in chilled chamber(s). The refrigerator appliances can also include various storage components mounted within the chilled chamber and designed to facilitate storage of food items therein. Such storage components can include racks, bins, shelves, or drawers that receive food items and assist with organizing and arranging of such food items within the chilled chamber.

Notably, it is frequently desirable to monitor food items in the refrigerator appliance, have knowledge of what food items are added to or removed from within the refrigerator appliance, and have other information related to the presence of food items. Certain conventional refrigerator appliances include a camera for monitoring food items as they are added or removed from the refrigerator appliance. However, while cameras are useful for imaging and/or identifying a particular object, they are frequently not capable of precisely identifying the location of an object within the chilled chamber. In addition, certain conventional refrigerator appliances might include weight sensors to detect when an object has been added to a shelf. However, the precise positioning of a food item cannot typically be determined using cameras or weight sensors alone.

Accordingly, a refrigerator appliance with systems for improved inventory management would be useful. More particularly, a refrigerator appliance that includes an inventory management system that is capable of monitoring entering and exiting inventory along with the positioning of objects within the chilled chamber would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a refrigerator appliance is provided including a cabinet defining a chilled chamber, a door being rotatably hinged to the cabinet to provide selective access to the chilled chamber, a noncontact scanning device mounted to the cabinet for monitoring the chilled chamber, and a controller operably coupled to the noncontact scanning device. The controller is configured to detect motion of an object at one or more locations within the chilled chamber and determine a position of the object within the chilled chamber using the noncontact scanning device.

In another exemplary embodiment, an inventory management system for a refrigerator appliance is provided. The refrigerator appliance includes a cabinet defining a chilled chamber. The inventory management system includes a noncontact scanning device mounted to the cabinet for monitoring the chilled chamber and a controller operably coupled to the noncontact scanning device, the controller being configured to detect motion of an object at one or more locations within the chilled chamber and determine a position of the object using the noncontact scanning device.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a refrigerator appliance according to an exemplary embodiment of the present subject matter.

FIG. 2 provides a perspective view of the exemplary refrigerator appliance of FIG. 1, with the doors of the fresh food chamber shown in an open position to reveal an inventory management system according to an exemplary embodiment of the present subject matter.

FIG. 3 provides a side view of the exemplary fresh food chamber and inventory management system of FIG. 2 according to an exemplary embodiment of the present subject matter.

FIG. 4 provides a side view of the exemplary fresh food chamber and inventory management system of FIG. 2 according to another exemplary embodiment of the present subject matter.

FIG. 5 provides a side view of the exemplary fresh food chamber and inventory management system of FIG. 2 according to another exemplary embodiment of the present subject matter.

FIG. 6 provides a side view of the exemplary fresh food chamber and inventory management system of FIG. 2 according to another exemplary embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

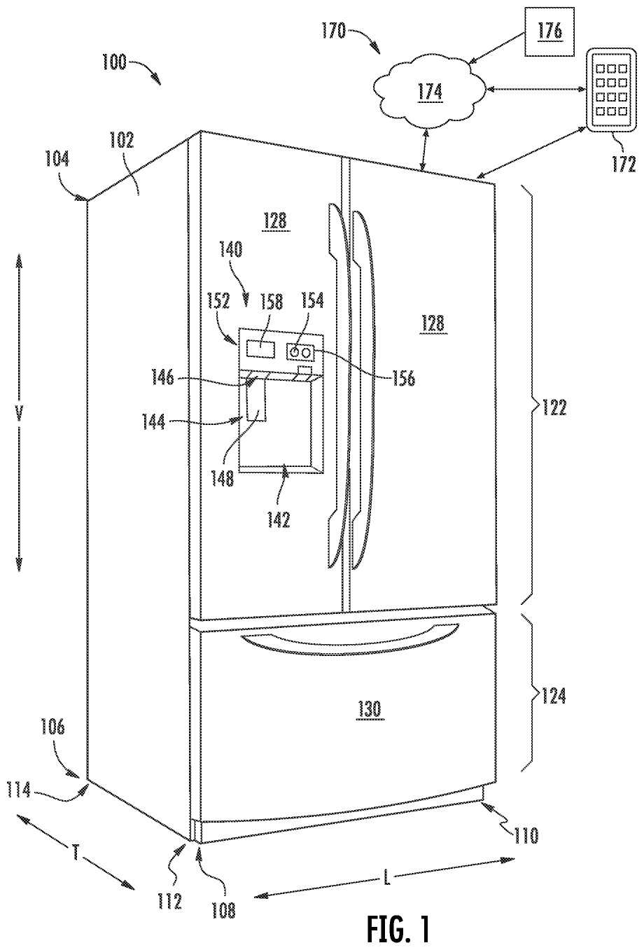

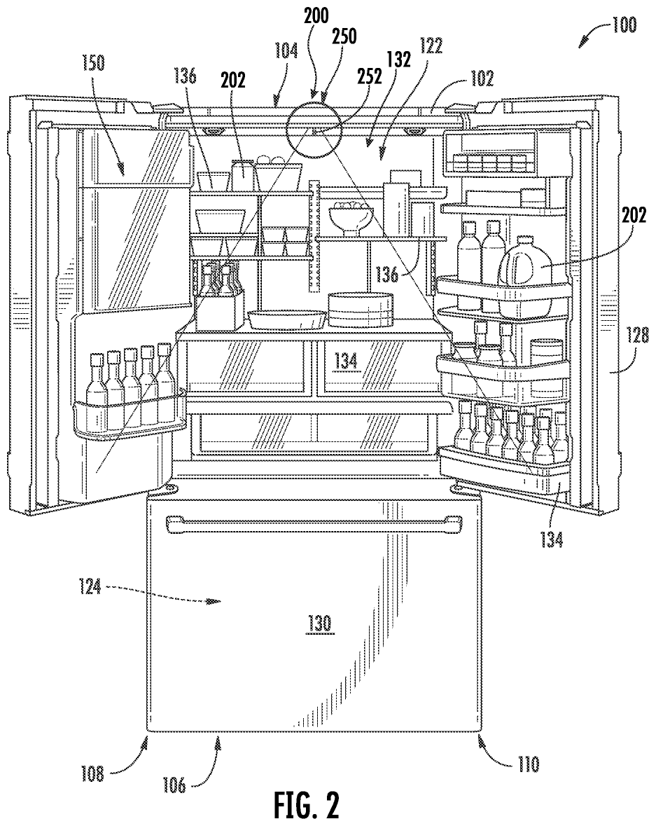

Referring now to the figures, an exemplary appliance will be described in accordance with exemplary aspects of the present subject matter. Specifically, FIG. 1 provides a perspective view of an exemplary refrigerator appliance 100 and FIG. 2 illustrates refrigerator appliance 100 with some of the doors in the open position. As illustrated, refrigerator appliance 100 generally defines a vertical direction V, a lateral direction L, and a transverse direction T, each of which is mutually perpendicular, such that an orthogonal coordinate system is generally defined.

According to exemplary embodiments, refrigerator appliance 100 includes a cabinet 102 that is generally configured for containing and/or supporting various components of refrigerator appliance 100 and which may also define one or more internal chambers or compartments of refrigerator appliance 100. In this regard, as used herein, the terms “cabinet,” “housing,” and the like are generally intended to refer to an outer frame or support structure for refrigerator appliance 100, e.g., including any suitable number, type, and configuration of support structures formed from any suitable materials, such as a system of elongated support members, a plurality of interconnected panels, or some combination thereof. It should be appreciated that cabinet 102 does not necessarily require an enclosure and may simply include open structure supporting various elements of refrigerator appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top 104 and a bottom 106 along the vertical direction V, between a first side 108 (e.g., the left side when viewed from the front as in FIG. 1) and a second side 110 (e.g., the right side when viewed from the front as in FIG. 1) along the lateral direction L, and between a front 112 and a rear 114 along the transverse direction T. In general, terms such as “left,” “right,” “front,” “rear,” “top,” or “bottom” are used with reference to the perspective of a user accessing appliance 102.

Housing 102 defines chilled chambers for receipt of food items for storage. In particular, housing 102 defines fresh food chamber 122 positioned at or adjacent top 104 of housing 102 and a freezer chamber 124 arranged at or adjacent bottom 106 of housing 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance, a side-by-side style refrigerator appliance, or a single door refrigerator appliance. Moreover, aspects of the present subject matter may be applied to other appliances as well. Consequently, the description set forth herein is for illustrative purposes only and is not intended to be limiting in any aspect to any particular appliance or configuration.

Refrigerator doors 128 are rotatably hinged to an edge of housing 102 for selectively accessing fresh food chamber 122. In addition, a freezer door 130 is arranged below refrigerator doors 128 for selectively accessing freezer chamber 124. Freezer door 130 is coupled to a freezer drawer (not shown) slidably mounted within freezer chamber 124. In general, refrigerator doors 128 form a seal over a front opening 132 defined by cabinet 102 (e.g., extending within a plane defined by the vertical direction V and the lateral direction L). In this regard, a user may place items within fresh food chamber 122 through front opening 132 when refrigerator doors 128 are open and may then close refrigerator doors 128 to facilitate climate control. Refrigerator doors 128 and freezer door 130 are shown in the closed configuration in FIG. 1. One skilled in the art will appreciate that other chamber and door configurations are possible and within the scope of the present invention.

FIG. 2 provides a perspective view of refrigerator appliance 100 shown with refrigerator doors 128 in the open position. As shown in FIG. 2, various storage components are mounted within fresh food chamber 122 to facilitate storage of food items therein as will be understood by those skilled in the art. In particular, the storage components may include bins 134 and shelves 136. Each of these storage components are configured for receipt of food items (e.g., beverages and/or solid food items) and may assist with organizing such food items. As illustrated, bins 134 may be mounted on refrigerator doors 128 or may slide into a receiving space in fresh food chamber 122. It should be appreciated that the illustrated storage components are used only for the purpose of explanation and that other storage components may be used and may have different sizes, shapes, and configurations.

Referring again to FIG. 1, a dispensing assembly 140 will be described according to exemplary embodiments of the present subject matter. Although several different exemplary embodiments of dispensing assembly 140 will be illustrated and described, similar reference numerals may be used to refer to similar components and features. Dispensing assembly 140 is generally configured for dispensing liquid water and/or ice. Although an exemplary dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 112 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142. By contrast, refrigerator door 128 may define an icebox compartment 150 (FIG. 2) housing an icemaker and an ice storage bin (not shown) that are configured to supply ice to dispenser recess 142.

A control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with a processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100, dispensing assembly 140 and other components of refrigerator appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring still to FIG. 1, a schematic diagram of an external communication system 170 will be described according to an exemplary embodiment of the present subject matter. In general, external communication system 170 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to refrigerator appliance 100, referred to generally herein as an external device 172. As described in more detail below, these communications may be facilitated using a wired or wireless connection, such as via a network 174. In general, external device 172 may be any suitable device separate from refrigerator appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with refrigerator appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information. According to exemplary embodiments, remote server 176 may be configured to receive and analyze images obtained by camera assembly 250, e.g., to facilitate inventory analysis.

In general, communication between refrigerator appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with refrigerator appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring now generally to FIGS. 2 through 6, refrigerator appliance 100 may further include an inventory management system 200 that is generally configured to monitor one or more chambers of refrigerator appliance 100 to monitor the addition or removal of inventory. More specifically, as described in more detail below, inventory management system 200 may include a plurality of sensors, cameras, or other detection devices that are used to monitor fresh food chamber 122 to detect objects (e.g., identified generally by reference numeral 202) that are positioned in or removed from fresh food chamber 122. In this regard, inventory management system 200 may use data from each of these devices to obtain a complete representation or knowledge of the identity, weight, position, and/or other qualitative or quantitative characteristics of objects 202 within fresh food chamber 122. Although inventory management system 200 is described herein as monitoring fresh food chamber 122 for the detection of objects 202, it should be appreciated that aspects of the present subject matter may be used to monitor objects or items in any other suitable appliance, chamber, etc.

As shown schematically in FIGS. 2 through 6, inventory management system 200 may include one or more noncontact scanning devices 210 that are mounted within cabinet 102 for monitoring fresh food chamber 122. More specifically, noncontact scanning devices 210 are generally configured to detect motion of an object (e.g., such as object 202 at one or more locations within fresh food chamber 122) and determine a precise position of object 202 within fresh food chamber 122. For example, noncontact scanning device 210 may be used to determine that object 202 had been placed on a lower shelf 136 along with the precise location of object 202 within a horizontal plane, e.g., such as the back left of shelf 136.

In general, noncontact scanning device 210 may include any suitable number, type, position, and configuration of sensors or devices that are used to identify a position or orientation of an object. For example, noncontact scanning device 210 may include at least one of a proximity sensor, a time-of-flight sensor, an infrared sensor, or an optical sensor. Specifically, noncontact scanning device 210 may include a light detection and ranging (LiDAR) sensor. In general, a LiDAR system may be positioned at any suitable location within fresh food chamber 122 (or in view of fresh food chamber 122) and may include an emitter and a receiver. According to exemplary embodiments, the emitter and the receiver are mounted on a single microchip or within a single device, as identified generally as noncontact scanning device 210, though other configurations are possible. As explained below, noncontact scanning device 210 may generally be configured to map object 202 and surrounding surfaces within fresh food chamber 122.

In general, the emitter may be the source of any form of energy which may be measured or detected by the receiver, e.g., for detecting the presence, location, geometry, and/or orientation of object 202. For example, according to the illustrated embodiment, the emitter and the receiver are an optical tracking system or laser tracking system. In this regard, for example, the emitter may include a laser diode or other suitable energy source for generating an energy beam (as identified generally by reference numeral 212). In general, the energy beam 212 may be any suitable form of electromagnetic energy having any suitable wavelength. For example, according to an exemplary embodiment, the energy beam 212 is electromagnetic energy having a wavelength of between about 500 and 1200 nm, or between about 700 and 1000 nm, or any other suitable wavelength. According to another exemplary embodiment, energy beam 212 is infrared light having a wavelength of approximately 940 nm.

Similarly, the receiver may include an optical sensor or other suitable detector or sensor. In this manner, for example, the emitter and the receiver may generally define and operate as a LiDAR system, e.g., for detecting energy beam 212 after it has reflected off object 202, shelf 136, cabinet 102, etc. However, according to alternative embodiments, the emitter and the receiver may rely on principles of electromagnetism or other optical or sonar means for detecting positional and geometric data of object 202. For example, according to alternative embodiments, noncontact scanning device 210 may include a radio wave-based radio detection and ranging sensor (radar) sensor. Other devices for measuring this data are possible and within the scope of the present subject matter.

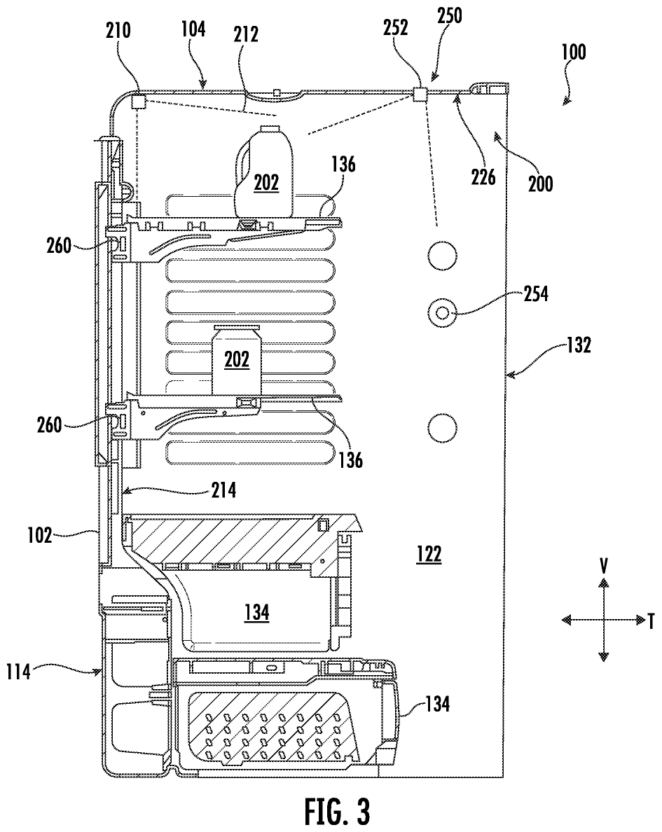

Notably, according to exemplary embodiments of the present subject matter, inventory management system 200 may include any suitable number, type, and position of noncontact scanning devices 210 for achieving a proper mapping of all regions of fresh food chamber 122. For example, referring briefly to FIG. 3, inventory management system 200 may include a single noncontact scanning device positioned proximate a top, back corner of fresh food chamber 122 (e.g., at a top 104 and rear 114 of cabinet 102). In addition, the field of view of noncontact scanning device 210 may be oriented forward along the transverse direction T toward front opening 132 and/or downward along the vertical direction V. In this manner, noncontact scanning device 210 may begin monitoring object 202 before it enters fresh food chamber 122. Notably, however, noncontact scanning device 210 may be oriented forward, as it does not introduce the same privacy concerns as if a camera were positioned at the same location and oriented in the same manner.

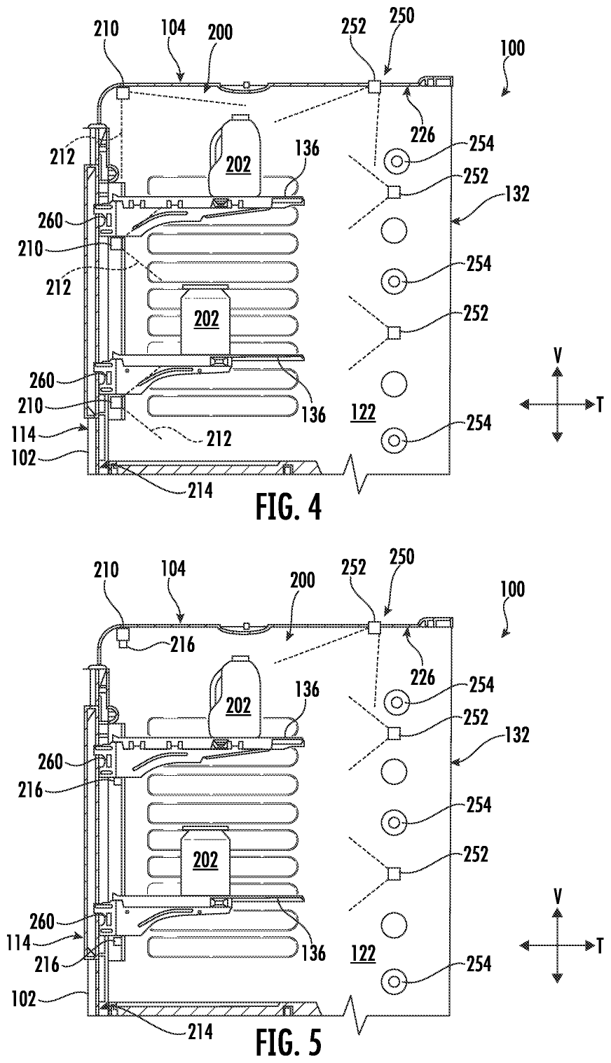

In order to obtain a better overall view or mapping of fresh food chamber 122, inventory management system 200 could alternatively include multiple noncontact scanning devices 210, e.g., as illustrated in FIG. 4. In this regard, multiple noncontact scanning devices 210 may be spaced apart along the vertical direction V and on a rear wall 214 of fresh food chamber 122. Each of these noncontact scanning devices 210 may be oriented such that their fields of view are directed forward along the transverse direction T. In addition, it should be appreciated that each noncontact scanning device may be pivotally mounted such that its angular orientation may be regulated using a drive mechanism.

Notably, the noncontact scanning devices 210 described above include three-dimensional LiDAR systems or sensors. However, according to alternative embodiments, a single one-dimensional laser scanning device or LiDAR sensor may be used. In this regard, as best shown in FIG. 5, a single one-dimensional noncontact scanning device 210 (e.g., a one-dimensional LiDAR sensor) may be mounted in a top rear corner of fresh food chamber 122 and inventory management system 200 may further include a series of mirrors 216 that are spaced at desired locations within fresh food chamber 122. In this manner, the emitter of the one-dimensional LiDAR system may emit of beam of energy 212 that is reflected off each mirror 216 such that the single sensor may obtain information regarding each region proximate to a respective mirror 216. Other sensor and mirror configurations are possible and within the scope of the present subject matter.

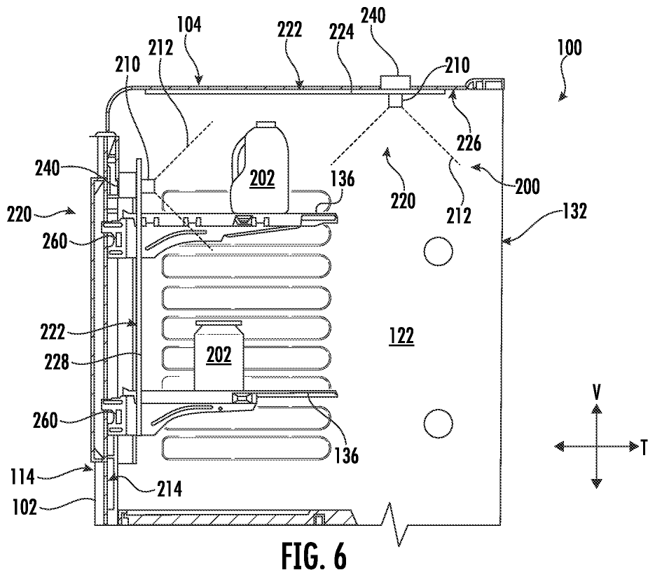

Referring now briefly to FIG. 6, inventory management system 200 may further include a positioning system 220 that is mounted within cabinet 102 and is generally configured to selectively position one or more noncontact scanning devices 210. For example, according to the illustrated embodiment, positioning system 220 includes one or more elongated tracks (e.g., identified generally by reference numeral 222). More specifically, positioning system 220 may include a first track 224 that is mounted to a top wall 226 of fresh food chamber 122 and is oriented along a transverse direction T. As illustrated, first track 224 extends generally from rear wall 214 to front opening 132 and is configured for supporting a single (or multiple) noncontact scanning devices 210.

In addition, positioning system 220 may include a second track 228 that is mounted to rear wall 214 of fresh food chamber 122 and is oriented generally along the vertical direction V. Second track 228 may generally be configured for receiving an auxiliary noncontact scanning device 210 that may be the same or similar to noncontact scanning device 210. According to exemplary embodiments, noncontact scanning device 210 and auxiliary noncontact scanning device 210 are generally slidably coupled to first track 224 and second track 228, respectively.

As shown schematically in FIG. 6, positioning system 220 may further include a belt drive system 240 that may be operated by a controller (e.g., such as controller 156) to selectively position the scanning device along the track. In this manner, controller 156 may selectively move noncontact scanning devices 210 along their respective elongated tracks 222 to obtain the desired field of view and generate a complete mapping of fresh food chamber 122 and objects 202 positioned therein. Although the drive system used for positioning system 220 is illustrated as a belt drive system 240, it should be appreciated that any other suitable drive system or mechanism may be used while remaining within scope the present subject matter. In addition, it should be appreciated that each noncontact scanning device 210 may be pivotally mounted to the respective elongated tracks 222 via a motor mount (not shown) such that controller 156 may selectively pivot noncontact scanning devices 210 relative to elongated tracks 222.

As displayed above, noncontact scanning devices 210 may be used to obtain or determined positioning of objects 202 within fresh food chamber 122. However, according to exemplary embodiments, it may be desirable to better understand qualitative or quantitative characteristics of objects 202 to facilitate improved inventory management. Accordingly, inventory management system 200 may further include a camera assembly 250 that is generally positioned and configured for obtaining images of refrigerator appliance 100 during operation. Specifically, according to the illustrated embodiment, camera assembly 250 includes a plurality of cameras 252 that are mounted to cabinet 102, to doors 128, or are otherwise positioned in view of fresh food chamber 122. Although camera assembly 250 is described herein as being used to monitor fresh food chamber 122 of refrigerator appliance 100, it should be appreciated that aspects of the present subject matter may be used to monitor any other suitable regions of any other suitable appliance, e.g., such as freezer chamber 124.

As best shown in FIGS. 2 through 5, the plurality of cameras 252 of camera assembly 250 are positioned around fresh food chamber 122 and are generally oriented toward a specific region or monitoring location. In this regard, for example, the field of view of each camera 252 may be limited to or focused on a specific area within fresh food chamber 122. Notably, however, it may be desirable to position each camera 252 proximate front opening 132 of fresh food chamber 122 and orient each camera 252 such that the field-of-view is directed into fresh food chamber 122. In this manner, privacy concerns related to obtaining images of the user of the appliance 100 may be mitigated or avoided altogether. According to exemplary embodiments, camera assembly 250 may be used to facilitate an inventory management process for refrigerator appliance 100. As such, each camera 252 may be positioned at an opening to fresh food chamber 122 to monitor food items (identified generally as objects 202) that are being added to or removed from fresh food chamber 122.

According to the illustrated embodiment, cameras 252 are spaced apart along the vertical direction V such that each camera 252 has a field of view in a certain region (e.g., top shelf, middle shelf, bottom shelf) and the camera assembly 250 as a whole has a substantially complete view of fresh food chamber 122. Thus, camera assembly 250 is generally configured for monitoring an entrance to fresh food chamber 122, e.g., for monitoring food items 202 being added or removed from fresh food chamber 122, as described in more detail below.

According to still other embodiments, each camera 252 may be oriented in any other suitable manner for monitoring any other suitable region within or around refrigerator appliance 100. It should be appreciated that according to alternative embodiments, camera assembly 250 may include any suitable number, type, size, and configuration of camera(s) 252 for obtaining images of any suitable areas or regions within or around refrigerator appliance 100. In addition, it should be appreciated that each camera 252 may include features for adjusting the field-of-view and/or orientation.

It should be appreciated that the images obtained by camera assembly 250 may vary in number, frequency, angle, resolution, detail, etc. in order to improve the clarity of the particular regions surrounding or within refrigerator appliance 100. In addition, according to exemplary embodiments, controller 156 may be configured for illuminating the chilled chamber using one or more light sources prior to obtaining images. Notably, controller 156 of refrigerator appliance 100 (or any other suitable dedicated controller) may be communicatively coupled to camera assembly 250 and may be programmed or configured for analyzing the images obtained by camera assembly 250, e.g., in order to identify items being added or removed from refrigerator appliance 100, as described in detail below.

Notably, according to exemplary embodiments of the present subject matter, data transmission and computer resources may be conserved by only operating those cameras 252 of camera assembly 250 that are detecting motion or moving objects, or which are otherwise in best view of such movements. As such, aspects of the present subject matter are directed to methods for detecting such motion and enabling/disabling cameras based on their proximity or field-of-view relative to the objects in motion. Although exemplary methods of detecting such motion and responsive actions are described herein, it should be appreciated that other methods for detecting motion and other responsive actions are possible and within the scope of the present subject matter.

According to exemplary embodiments one method of detecting motion may be implementing image analysis using sequentially obtained images, as will be described in more detail below. According to another exemplary embodiment, detecting such motion may rely on one or more motion sensors 254 that are positioned within or mounted to cabinet 102 for detecting such motion. According to exemplary embodiments, motion sensors 254 may be any suitable optical, acoustic, electromagnetic, or other sensors suitable for detecting motion within a space. For example, these motion sensors may include proximity sensors, time of flight sensors, infrared sensors, optical sensors, etc.

In general, each motion sensor 254 may establish a baseline for comparison, e.g., associated with a reading when no motion is detected. Thus the system of motion sensors 254 may form a grid or array from which motion may be detected. Each motion sensor 254 may be used to estimate the distance from the moving object or determine a proximity of that object to the camera 252. The object in motion may be virtualized into a two-dimensional position by analyzing and comparing feedback from some or all sensors 254. For example, if the top two sensors detect motion, then object is likely between those sensors 254 along the vertical direction V. It should be appreciated that weighted averaging may be used to obtain an accurate prediction of the location where motion is occurring. In addition, it should be appreciated that the sensor configuration and analysis methods are only exemplary and may vary while remaining within the scope of the present subject matter.

According to exemplary embodiments, controller 156 may activate only one camera 252 that is closest to the location of motion, or any other suitable configuration of cameras to best obtain an image or images of the region where motion is located. Although motion sensors 254 are illustrated herein as being interspaced or positioned between cameras 252, it should be appreciated that according to exemplary embodiments, each motion sensor 254 may be co-located with and/or associated with a specific camera 252 of camera assembly 250. Exemplary methods of using motion sensors 254 will be described below in more detail.

In general, controller 136 may be operably coupled to camera assembly 250 for analyzing one or more images obtained by camera assembly 250 to extract useful information regarding objects 202 located within fresh food chamber 122. In this regard, for example, images obtained by camera assembly 250 may be used to extract a barcode, identify a product, or obtain other product information related to object 202. Notably, this analysis may be performed locally (e.g., on controller 156) or may be transmitted to a remote server (e.g., remote server 176 via external communication network 170) for analysis. Such analysis is intended to facilitate inventory management, e.g., by identifying a food item being added to or removed from the chilled chamber.

According to exemplary embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor a moving object within fresh food chamber 122. It should be appreciated that this image analysis or processing may be performed locally (e.g., by controller 156) or remotely (e.g., by offloading image data to a remote server or network, e.g., remote server 176).

Specifically, the analysis of the one or more images may include implementation an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance. For example, image differentiation may be used to determine when a pixel level motion metric passes a predetermined motion threshold.

The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image. In addition, or alternatively, the image processing algorithms may use other suitable techniques for recognizing or identifying particular items or objects, such as edge matching, divide-and-conquer searching, greyscale matching, histograms of receptive field responses, or another suitable routine (e.g., executed at the controller 156 based on one or more captured images from one or more cameras). Other image processing techniques are possible and within the scope of the present subject matter.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the exemplary image analysis or evaluation processes described below may be used independently, collectively, or interchangeably to extract detailed information regarding the images being analyzed to facilitate performance of one or more methods described herein or to otherwise improve appliance operation. According to exemplary embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an exemplary embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different than R-CNN. For example, R-CNN first applies a convolutional neural network (“CNN”) and then allocates it to zone recommendations on the covn5 property map instead of the initially split into zone recommendations. In addition, according to exemplary embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used but use of such techniques is not required. If using transfer techniques learning, a neural network architecture may be pretrained such as VGG16/VGG19/ResNet50 with a public dataset then the last layer may be retrained with an appliance specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to exemplary embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only exemplary and are not intended to limit the scope of the present subject matter in any manner.

As explained above, noncontact scanning devices 210 may be particularly suited to determining the position of objects 202 within fresh food chamber 122. In addition, camera assembly 250 may be particularly suited to identifying an object, reading a barcode, or determining other useful qualitative or quantitative information related to the object 202. However, it may be further desirable to determine the weight of the object 202 within fresh food chamber 122. Accordingly, inventory management system 200 may further include one or more weight sensors 260 that are provided within fresh food chamber 122, as will be described in greater detail below. Generally, weight sensor 260 is provided as or includes any suitable electronic load sensor or cell configured to generate one or more electronic signals according to (e.g., in proportion to) a load positioned thereon. For instance, weight sensor 260 may include a suitable strain gauge, force sensitive resistor, capacitance sensor, hydraulic sensor (e.g., having a deformable hydraulic tube), or pneumatic sensor (e.g., having a deformable pneumatic tube)—as would be understood.

As noted above, one or more weight sensors 260 may be operably coupled to each shelf 136 (e.g., or a portion of shelf 136), each bin 134, or any other suitable location for measuring the weight of an object 202. Specifically, for example, such weight sensors 210 may be mounted in mechanical communication with each shelf 136 to detect the weight or mass supported thereon. For example, when an object 202 is added to or removed from fresh food chamber 122, weight sensor 260 may detect a change in shelf weight to determine the weight of object 202 added or removed. Notably, weight sensor 260 may further be used in conjunction with noncontact scanning devices 210 in order to precisely determine the location or position of objects 202 within fresh food chamber 122.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance comprising:
a cabinet defining a chilled chamber;
a door being rotatably hinged to the cabinet to provide selective access to the chilled chamber;
a noncontact scanning device mounted to the cabinet for monitoring the chilled chamber; and
a controller operably coupled to the noncontact scanning device, the controller being configured to:
detect motion of an object at one or more locations within the chilled chamber; and
determine a position of the object within the chilled chamber using the noncontact scanning device.

2. The refrigerator appliance of claim 1, wherein the noncontact scanning device comprises at least one of a proximity sensor, a time-of-flight sensor, an infrared sensor, or an optical sensor.

3. The refrigerator appliance of claim 1, wherein the noncontact scanning device comprises a light detection and ranging (LiDAR) sensor or a radio wave-based radio detection and ranging sensor (radar) sensor.

4. The refrigerator appliance of claim 1, wherein the noncontact scanning device comprises a one-dimensional laser scanning device, the refrigerator appliance further comprising:
one or more mirrors for redirecting at least a portion of light emitted from the one-dimensional laser scanning device.

5. The refrigerator appliance of claim 1, wherein the noncontact scanning device comprises a three-dimensional laser scanning device.

6. The refrigerator appliance of claim 1, wherein the refrigerator appliance further comprises:
a positioning system mounted within the cabinet for selectively positioning the noncontact scanning device.

7. The refrigerator appliance of claim 6, wherein the positioning system comprises:
one or more elongated tracks, the noncontact scanning device being slidably received within the one or more elongated tracks; and
a belt drive system operably coupled to the noncontact scanning device for selectively sliding the noncontact scanning device along the one or more elongated tracks.

8. The refrigerator appliance of claim 7, wherein the one or more elongated tracks comprise:
a first track mounted to a top wall of the cabinet and being oriented along a transverse direction for receiving the noncontact scanning device; and
a second track mounted to a back wall of the cabinet and being oriented along a vertical direction for receiving an auxiliary noncontact scanning device.

9. The refrigerator appliance of claim 1, wherein the noncontact scanning device is mounted for monitoring a first region within the chilled chamber, the refrigerator appliance further comprising:
an auxiliary noncontact scanning device monitoring a second region within the chilled chamber.

10. The refrigerator appliance of claim 1, further comprising:
a camera assembly mounted to the cabinet for monitoring the chilled chamber.

11. The refrigerator appliance of claim 10, wherein the camera assembly is positioned at a front opening of the chilled chamber and has a field of view directed into the chilled chamber.

12. The refrigerator appliance of claim 10, wherein the controller is operably coupled to the camera assembly, the controller being configured to:
obtain one or more images of the object in the chilled chamber using the camera assembly.

13. The refrigerator appliance of claim 12, wherein the controller is configured to analyze the one or more images to extract a barcode, identify a product, or obtain other product information related to the object.

14. The refrigerator appliance of claim 12, wherein the controller is configured to analyze the one or more images using an image processing technique or a machine learning image recognition process.

15. The refrigerator appliance of claim 1, further comprising:
a weight sensor operably coupled to a shelf for detecting a weight of the shelf, wherein the controller is operably coupled to the weight sensor for determining a placement location of the object or measuring a weight of the object when the object is placed on the shelf.

16. An inventory management system for a refrigerator appliance, the refrigerator appliance comprising a cabinet defining a chilled chamber, the inventory management system comprising:
a noncontact scanning device mounted to the cabinet for monitoring the chilled chamber; and
a controller operably coupled to the noncontact scanning device, the controller being configured to:
detect motion of an object at one or more locations within the chilled chamber; and
determine a position of the object using the noncontact scanning device.

17. The inventory management system of claim 16, wherein the noncontact scanning device comprises at least one of a proximity sensor, a time-of-flight sensor, an infrared sensor, or an optical sensor.

18. The inventory management system of claim 16, further comprising:
a positioning system mounted within the cabinet for selectively positioning the noncontact scanning device.

19. The inventory management system of claim 16, further comprising:
a camera assembly mounted to the cabinet for monitoring the chilled chamber, wherein the camera assembly is positioned at a front opening of the chilled chamber and has a field of view directed into the chilled chamber.

20. The inventory management system of claim 16, further comprising:
a weight sensor operably coupled to a shelf for detecting a weight of the shelf, wherein the controller is operably coupled to the weight sensor for determining a placement location of the object or measuring a weight of the object when the object is placed on the shelf.
